(19) United States
(12) Patent Application Publication
(10) Pub. No.: US 2007/0171213 A1
(43) Pub. Date: Jul. 26, 2007

(54) Stylus pen

(75) Inventors: Tzu-Ming Yang, Taipei (TW); Ming-Chin Yang, Taipei (TW); Chia-Huang Chan, Taipei (TW)

Correspondence Address: RABIN & Berdo, PC, 1101 14TH STREET, NW, SUITE 500, WASHINGTON, DC, 20005, US

(73) Assignee: ASUSTek COMPUTER INC., Taipei (TW)

(21) Appl. No.: 11/654,552

(22) Filed: Jan. 18, 2007

(30) Foreign Application Priority Data
Jan. 25, 2006 (TW) 95102919

(51) Int. Cl. G06F 3/033

(52) U.S. Cl. 345/179

(57) ABSTRACT

A stylus pen used for a touch screen is provided. The stylus pen includes a holding part and a pen nib. The holding part includes a main part, a first casing and a second casing. The pen nib is used for touching the touch screen. One end of the pen nib is wedged with the main part. The first casing and the second casing clamp the main part and the pen nib. The pen nib is separateable from the holding part.

This application claims the benefit of Taiwan application Serial No. 095102919, filed Jan. 25, 2006, the subject matter of which is incorporated herein by reference.

### BACKGROUND OF THE INVENTION

1. Field of the Invention

The invention relates in general to a stylus pen, and more particularly to a stylus pen whose pen nib is replaceable.

2. Description of the Related Art

With the advance in technology, many electronic products replace the mouse and keyboard by a touch screen for the convenience of instruction input. The touch screen is now widely applied to electronic devices such as personal digital assistant (PDA), mobile phone, notebook, flat-panel computer and enquiry computer. The user can input an instruction by pressing or moving a finger or a stylus pen on the touch screen. After the instruction is received by the touch screen, the instruction is transmitted to the computer host for further processing.

However, the pen nib of the stylus pen would wear out and become smooth after a long duration of service. A smooth pen nib is lack of friction when contacting the touch screen. There, as the user writes to input an instruction, the pen nib would easily slide on the surface of the touch screen, making it difficult for the user to effectively control the input of digital signals and line traces. Thus, a conventional touch screen normally provides several stylus pens or the user has to buy a new stylus pen when necessary.

Moreover, the stylus pen can be disposed in the electronic product when not used and removed from the electronic product when in use. However, the conventional stylus pen is often misplaced due to negligence, causing great inconvenience to the user.

Besides, the shape and length of a conventional stylus pen is similar to an ordinary ball pen or pencil. Under the current trend of lightweight, slimness and compactness in the design of electronic products, the conventional stylus pen occupies too large space, hence making it difficult to reduce the size of electronic products. The conventional stylus pen has above disadvantages, not only incurring more purchase costs but also causing inconvenience to the user. Therefore, how to resolve the above problems has become an imminent issue.

### SUMMARY OF THE INVENTION

It is therefore an object of the invention to provide a stylus pen. The user can easily replace the pen nib, and have the stylus pen on his person, not only largely reducing the space and the cost of replacing the stylus pen, but also effectively reducing the risk of the misplacing the stylus pen and bringing great convenience to the user.

The invention achieves the above-identified object by providing a stylus pen used for a touch screen. The stylus pen includes a holding part and a pen nib. The holding part includes a main part, a first casing and a second casing. The pen nib is used for touching the touch screen. One end of the pen nib is wedged with the main part. The first casing and the second casing together clamp the main part and the pen nib. The pen nib is separateable from the holding part.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a schematic illustration of a stylus pen according to a preferred embodiment of the invention;

FIG. 2 shows a disassembly diagram of the holding part of FIG. 1; and

FIG. 3 shows the pen nib of FIG. 2 disassembled on the main part.

### DETAILED DESCRIPTION OF THE INVENTION

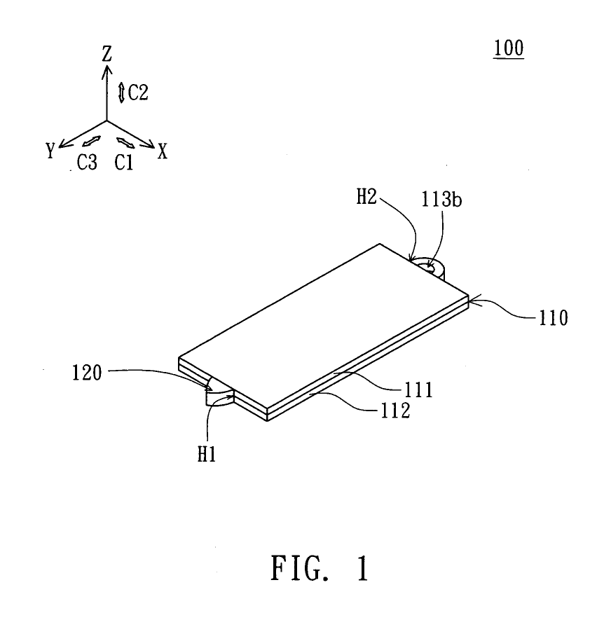

Referring to FIG. 1, a schematic illustration of a stylus pen according to a preferred embodiment of the invention is shown. The stylus pen 100 is used for touching a touch screen to control the touch screen. Examples of the electronic device with a touch screen include personal digital assistant (PDA), notebook, flat-panel computer and mobile phone. The stylus pen 100 includes a holding part 110 and a pen nib 120. The user clamps the holding part 110 by the tip of the thumb and the tip of the index finger. The pen nib 120 is coupled to the holding part 110 for touching the touch screen. The pen nib 120 is separateable from the holding part 110, and the replacement of the pen nib 120 can be done by the user. The pen nib 120 is made from plastics, metal or hard material. However, the material of the stylus pen 100 is not for limiting the scope of technology of the invention.

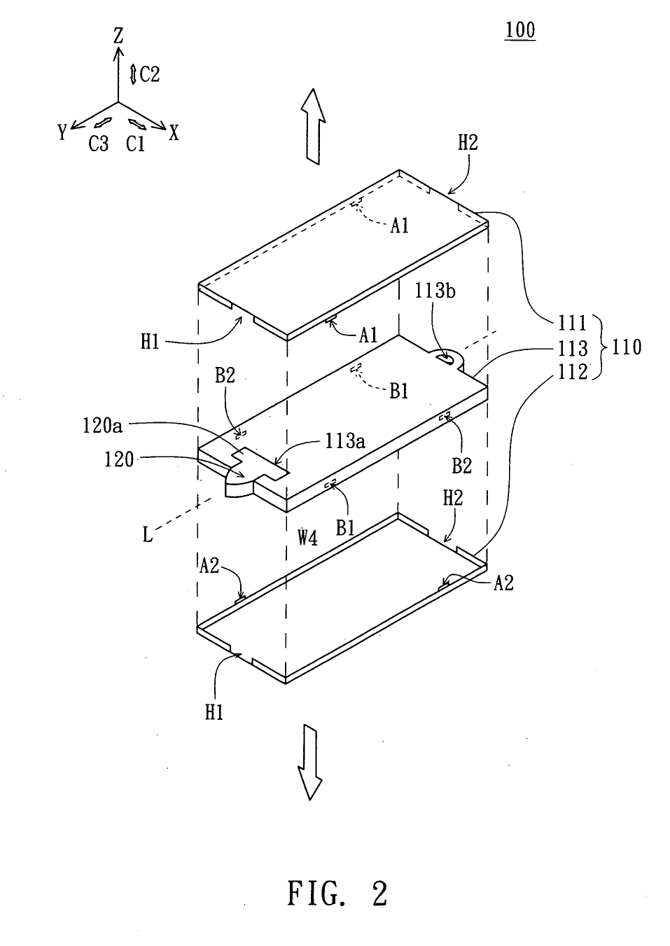

Referring to FIG. 2, a disassembly diagram of the holding part of FIG. 1 is shown. The holding part 110 includes a main part 113, a first casing 111 and a second casing 112. The main part 113 is disposed between the first casing 111 and the second casing 112. The user can easily disassemble the first casing 111 and the second casing 112. The first casing 111 has two first hooks Al, the second casing 112 has two second hooks A2, and the main part 113 has two first recesses B1 and two second recesses B2. As the first hooks A1 are inserted into the first recesses B1, the first casing 111 is wedged with the main part 113, and as the second hooks A2 are inserted into the second recesses B2, the second casing 112 is wedged with the main part 113, such that the main part 113 is clamped by the first casing 111 and the second casing 112. Through such design, the user further can easily disassemble the first casing 111 and the second casing 112 in a reverse sequence.

Despite the present embodiment of the invention is exemplified by two first hooks A1, two second hooks A2, two second hooks recesses B1 and two second hooks recesses B2, however, the number of the first hook A1, the second hook A2, the second recess B1 and the second recess B2 is not for limiting the invention. Any structural designs capable of clamping the main part 113 and the pen nib 120 firmly by the first casing 111 and the second casing 112 which can be easily disassembled are within the scope of the technology of the invention.

As indicated in FIG. 2, the first casing 111 and the second casing 112 togther clamp the main part 113 and the pen nib 120, and one end of the pen nib 120 is wedged with the main part 113. The first casing 111 and the second casing 112 further form a first through hole H1, and the other end of the pen nib 120 is protruded from the first through hole H1.

The main part 113 has an engaging recess 113a, and the pen nib 120 has an engaging bump 120a wedged with the engaging recess 113a for coupling the pen nib 120 and the main part 113.

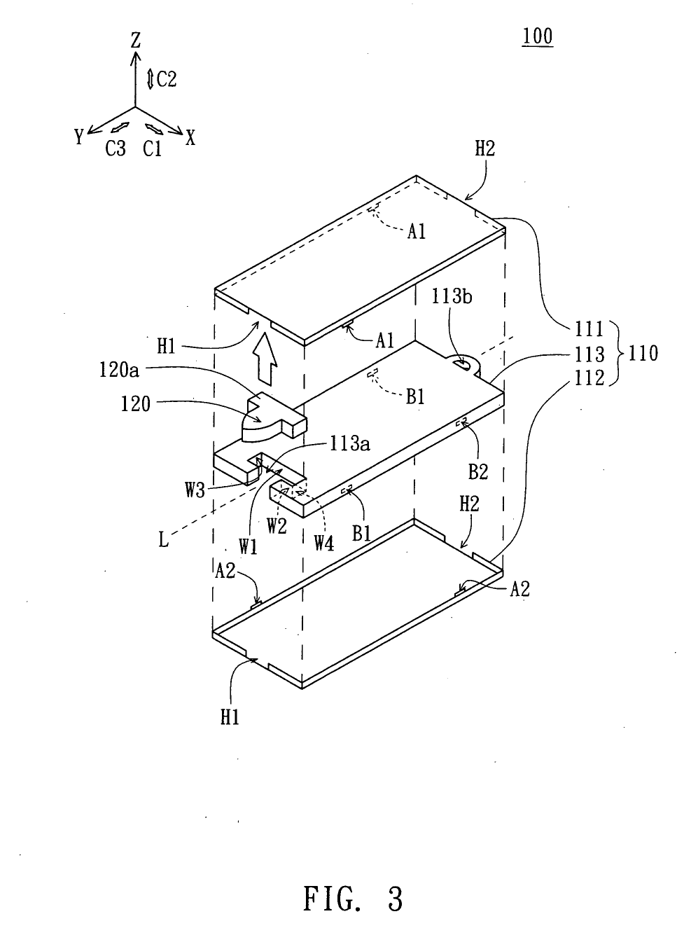

Referring to FIG. 3, the pen nib of FIG. 2 disassembled on the main part is shown. The user can separate the engaging bump 120a of the pen nib 120 from the engaging recess 113a, such that the pen nib 120 is disassembled on the main part 113.

As indicated in FIG. 3, the stylus pen 100 has a symmetric central axis L, and the engaging recess 113a has a first wall W1 and a second wall W2. The normal line of the first wall W1 and the normal line of the second wall W2 are parallel to the symmetric central axis L for restricting the pen nib 120 to shift along a direction C3 (such as the Y-axial direction as indicated in the diagram) of the symmetric central axis L with respect to the main part 113.

The engaging recess 113a further has a third wall W3 and a fourth wall W4. The normal line of the third wall W3 and the normal line of the fourth wall W4 are perpendicular to the symmetric central axis L for restricting the pen nib 120 to shift along a first direction C1 (such as the X-axial direction indicated in the diagram) with respect to the main part 113. The first direction C1 is perpendicular to the symmetric central axis L.

The first casing 111 and the second casing 112 together clamp the pen nib 120 along a second direction C2 for restricting the pen nib 120 to shift along a second direction C2 (such as the Z-axial direction indicated in the diagram) with respect to the main part 113. The second direction C2 is perpendicular to the symmetric central axis L and the first direction C1.

Preferably, the first casing 111 and the second casing 112 further form a second through hole H2, and one end of the main part 113 is protruded from the second through hole H2. The main part 113 further has a hanging hole 113b disposed at the one end of the main part 113 protruded from the second through hole H2. The stylus pen 100 further includes a plumb line passing through the hanging hole 113b for hanging the stylus pen 100. Availed by the plumb line, the user can wear the stylus pen 100 or have the stylus pen 100 hanged to a backpack, such that the stylus pen 100 can be independently disposed outside the touch screen.

Through structural design, the stylus pen disclosed in the above embodiment of the invention enables the user to easily replace the pen nib, and wear the pen nib or have the pen nib hanged to a backpack, not only largely reducing the space and the cost of replacing the stylus pen, but also effectively reducing the risk of the misplacing the stylus pen and bringing great convenience to the user.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A stylus pen used for a touch screen, the stylus pen comprising:
a holding part, comprising:
a main part;
a first casing; and
a second casing; and
a pen nib used for touching the touch screen, wherein one end of the pen nib is wedged with the main part, the first casing and the second casing clamp the main part and the pen nib, and the pen nib is separateable from the holding part.

2. The stylus pen according to claim 1, wherein the first casing and the second casing form a first through hole, and the other end of the pen nib is protruded from the first through hole.

3. The stylus pen according to claim 2, wherein the main part has an engaging recess, the pen nib has an engaging bump, and the engaging bump is wedged with the engaging recess for coupling the pen nib and the main part.

4. The stylus pen according to claim 3, wherein the stylus pen has a symmetric central axis, the engaging recess has a third wall and a fourth wall, the normal line of the third wall and the normal line of the fourth wall are perpendicular to the symmetric central axis for restricting the pen nib to shift along a first direction with respect to the main part, and the first direction is perpendicular to the symmetric central axis.

5. The stylus pen according to claim 3, wherein the stylus pen has a symmetric central axis, the first casing and the second casing clamp the pen nib along a second direction for restricting the pen nib to shift along the second direction with respect to the main part, and the second direction is perpendicular to the symmetric central axis.

6. The stylus pen according to claim 3, wherein the stylus pen has a symmetric central axis, the engaging recess has a first wall and a second wall, the normal line of the first wall and the normal line of the second wall are parallel to the symmetric central axis for restricting the pen nib to shift along the direction of symmetric central axis with respect to the main part.

7. The stylus pen according to claim 6, wherein the engaging recess has a third wall and a fourth wall, the normal line of the third wall and the normal line of the fourth wall are perpendicular to the symmetric central axis for restricting the pen nib to shift along a first direction with respect to the main part, the first direction is perpendicular to the symmetric central axis.

8. The stylus pen according to claim 7, wherein the first casing and the second casing clamp the pen nib along a second direction for restricting the pen nib to shift along the second direction with respect to the main part, and the second direction is perpendicular to the symmetric central axis and the first direction.

9. The stylus pen according to claim 1, wherein the first casing has a first hook, the second casing has a second hook, the main part has a first recess and a second recess, the first casing is wedged with the main part after the first hook is inserted into the first recess, and the second casing is wedged with the main part after the second hook is inserted into the second recess, such that the first casing and the second casing clamp the main part.

10. The stylus pen according to claim 1, wherein the main part further has a hanging hole, the stylus pen further comprises a plumb line passing through the hanging hole for hanging the stylus pen.

11. The stylus pen according to claim 1, wherein the pen nib is made from a plastic material, a metal material or a hard material.

12. The stylus pen according to claim 1, wherein the touch screen is the touch screen of a personal digital assistant (PDA), a notebook, a flat-panel computer or a mobile phone.
